(19) United States
(12) Patent Application Publication
(10) Pub. No.: US 2015/0207242 A1
(43) Pub. Date: Jul. 23, 2015

(54) CONNECTOR

(71) Applicant: Yazaki Corporation, Tokyo (JP)

(72) Inventors: Daisuke SUGIYAMA, Shizuoka (JP); Tsutomu SAWADA, Shizuoka (JP); Takashi TSUKAMOTO, Shizuoka (JP)

(73) Assignee: Yazaki Corporation, Tokyo (JP)

(21) Appl. No.: 14/675,963

(22) Filed: Apr. 1, 2015

Related U.S. Application Data
(63) Continuation of application No. PCT/JP2013/076785, filed on Oct. 2, 2013.

(30) Foreign Application Priority Data
Oct. 3, 2012 (JP) 2012-221053

(51) Int. Cl. H01R 4/48

(52) U.S. Cl. CPC H01R 4/489

(57) ABSTRACT

A connector includes: a male connector housing having a terminal housing; and a female terminal housed in the terminal housing, and including terminal connection parts into which a male terminal can be inserted. The female terminal is housed so as to be capable of moving in the terminal housing in the insertion direction of the male terminal, and includes a pressure-receiving part to be pressed by the male terminal during the insertion process of the male terminal. Each of the terminal connection parts is positioned at a non-touching position separate from the inserted male terminal, and provided so as to be capable of changing position to a touching position touching the male terminal. The male connector housing is provided with a tapering surface to be pressing the terminal connection parts towards the touching position using the pressure of the male terminal during the movement process of the female terminal.

### CROSS REFERENCE TO RELATED APPLICATIONS

This application is a continuation of International Application No. PCT/JP2013/076785, filed Oct. 2, 2013, and based upon and claims the benefit of priority from Japanese Patent Application No. 2012-221053, filed Oct. 3, 2012, the entire contents of all of which are incorporated herein by reference.

### TECHNICAL FIELD

The present application relates to a connector having a female terminal.

### BACKGROUND

This kind of connector has a connector housing and a female terminal accommodated in the connector housing. For a conventional female terminal, for example, there is one illustrated in FIGS. 1A to 1C (refer to JP H10-116644 A).

As illustrated in FIGS. 1A to 1C, a conventional female terminal 50 includes a cylindrical terminal connection part 51 into which a male terminal (not illustrated) is inserted. The terminal connection part 51 is partitioned into four partitioned cylindrical parts 53 by slits 52. In a position close to a leading end of each partitioned cylindrical part 53, a contact part 54 is formed so as to project from an inner face of each cylindrical part 53.

The male terminal (not illustrated) is inserted into the terminal connection part 51 of the female terminal 50 during the engagement process between connectors. Then, by pressure through the male terminal, respective partitioned cylindrical parts 53 deform elastically in a direction to increase a terminal's diameter, so that the insertion of the male terminal is permitted. The male terminal is inserted to an insertion completion position while sliding on the contact parts 54 of respective partitioned cylindrical parts 53. In the insertion completion position, the male terminal comes into contact with respective contact parts 54 of the female terminal 50 by elastic restoring force.

### SUMMARY

In the conventional female terminal 50, during the insertion process of the male terminal (not illustrated), however, as the male terminal slides on the contact parts 54 from a point of time when the male terminal comes in touch with the contact parts 54 of the female terminal 50 up to a point of time when the male terminal reaches the insertion completion position, the sliding stroke is long and the sliding wear is large. In the female terminal 50, especially, its wear is large in comparison with that of the male terminal since only the contact parts 54 slide on the male terminal. In this way, large sliding wear causes low durability of the terminal. Consequently, it is necessary to increase a plating thickness to improve the durability of the terminal related to the sliding wear, causing a price increasing of the terminal.

Under such a situation, an object of the present application is to provide a connector which is capable of reducing sliding wear of the terminal and also realizing cost reductions.

A connector according to a first aspect of the present application includes a connector housing having a terminal housing and a female terminal housed in the terminal housing and having a terminal connection part into which a male terminal can be inserted. The female terminal is housed so as to be capable of moving in the terminal housing in an insertion direction of the male terminal and includes a pressure-receiving part to be pressed by the male terminal during an insertion process of the male terminal. The terminal connection part is positioned at a non-touching position separated from the inserted male terminal and provided so as to be capable of changing a position to a touching position where the terminal connection part comes in touch with the male terminal. The connector housing is provided with a pressing part to be pressing the terminal connection part toward the touching position during a movement process of the female terminal due to a pressure of the male terminal.

The terminal connection part may be provided with tapering parts which are inclined so as to broaden an interval between the tapering parts as going toward an opposite direction to the insertion direction of the male terminal and additionally, the pressing part may be a tapering surface which is formed on an inner face of the terminal housing to press the tapering parts.

The terminal connection part may be provided with tapering parts which are inclined so as to broaden an interval between the tapering parts as going toward an opposite direction to the insertion direction of the male terminal and additionally, the pressing part may be a pressing projection part which projects into the terminal housing to press the tapering parts.

With the connector according to the aspect of the present application, in the process of inserting the male terminal into the terminal connection part, since at least the female terminal does not slide on the contact part of the female terminal till the male terminal presses the pressure-receiving part of the female terminal so that the terminal connection part receives the pressing force in the direction of touching, from the male terminal, the sliding stroke of the male terminal is shortened by just that much. Consequently, it is possible to reduce the sliding wear of the terminal and realize cost reductions.

### BRIEF DESCRIPTION OF DRAWINGS

FIG. 1A is a front view of a conventional female terminal, FIG. 1B is a sectional view taken along a line X-X of FIG. 1A, and FIG. 1C is an enlarged view of an essential part of FIG. 1B.

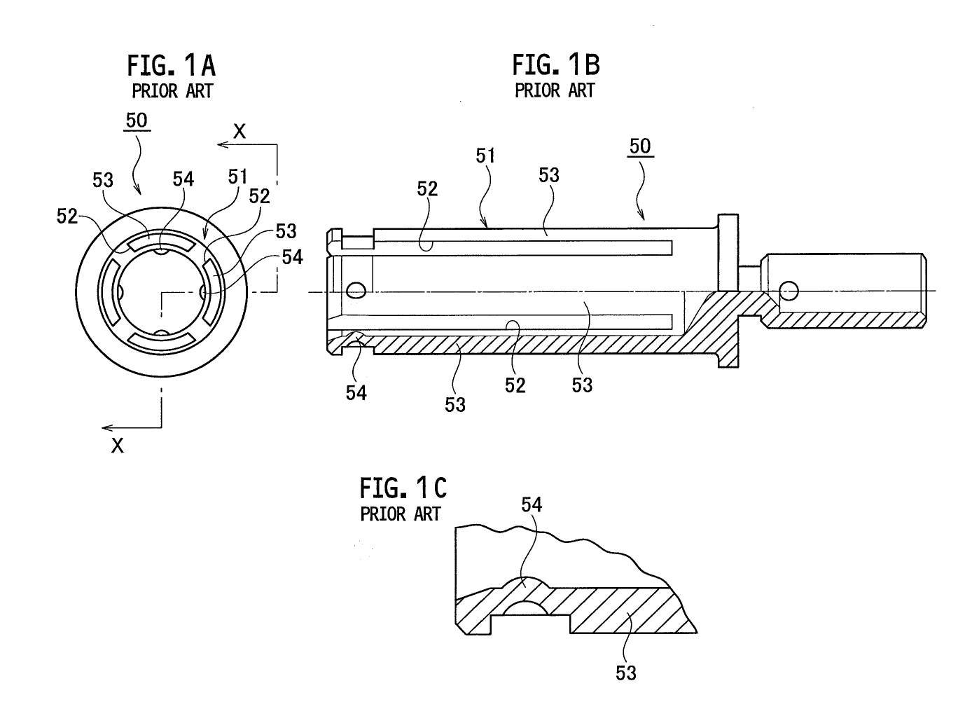

FIG. 2 is a sectional view of a female connector and a male connector according to a first embodiment, in a condition before their engagement.

FIGS. 3A to 3C are respective sectional views illustrating the engagement process between the female connector and the male connector according to the first embodiment.

FIG. 4 is a sectional view of a female connector and a male connector according to a second embodiment.

FIGS. 5A to 5C are respective sectional views illustrating the engagement process between the female connector and the male connector according to the second embodiment.

### DESCRIPTION OF EMBODIMENTS

Embodiments will be described with reference to drawings, below.

### First Embodiment

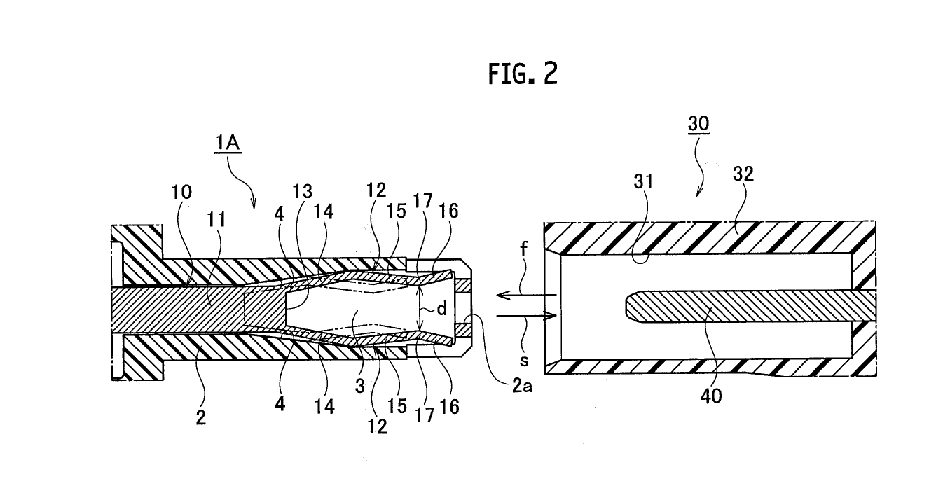

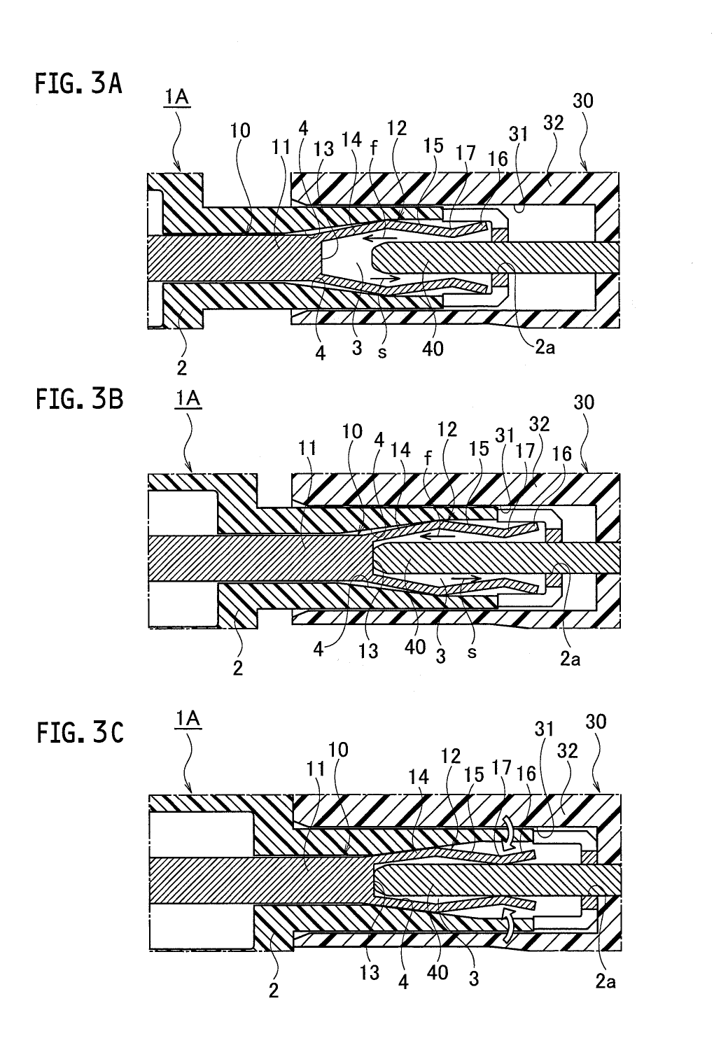

FIGS. 2 and 3 illustrate a first embodiment. For instance, a first connector 1A according to the first embodiment is applied to a charge connector on the side of a charging apparatus, such as a charging station, while a second connector 30 is applied to a charge inlet apparatus on the side of a vehicle to be supplied with electricity through the charge connector.

As illustrated in FIG. 2, the first connector 1A according to the first embodiment includes a male connector housing 2 having a terminal housing 3, and a female terminal 10 housed in the terminal housing 3.

The terminal housing 3 is set to be larger than a dimension of the female terminal 10 in the longitudinal direction. A terminal insertion slot 2a opens on the side of one end of the terminal housing 3. The male terminal 40 is inserted through the terminal insertion slot 2a. Formed inside the terminal housing 3 and on two surfaces opposing each other are tapering surfaces 4 which serve as a pressing part. The tapering surfaces 4 are inclined so as to gradually narrow a width of the terminal housing 3 as going toward an insertion direction f of the male terminal 40.

The female terminal 10 is housed so as to be capable of moving in the terminal housing 3 in insertion/withdrawal directions (i.e. an insertion direction f and a withdrawal direction s as the opposite direction). More specifically, the female terminal 10 is movable between a forward standby position illustrated with a solid line and a rearward contact position illustrated with an imaginary line in FIG. 2. Before the male terminal 40 is inserted, the female terminal 10 is positioned at the forward standby position. The female terminal 10, which is made from a conductive member, includes a base part 11 and a pair of terminal connection parts 12 whose base end sides are supported by the base part 11. A toe face of the base part 11 is defined as a pressure-receiving part 13. When the female terminal 10 is positioned at the forward standby position, the pressure-receiving part 13 is positioned at a position where it is pressed by a tip of the male terminal 40 in the second-half stroke of the insertion process of the male terminal 40.

The terminal connection parts 12 in pairs are separated from each other at an interval. Each of the terminal connection parts 12 includes a back-side tapering part 14, an intermediate inverse-tapering part 15, and a tip-side tapering part 16. The back-side tapering parts 14 are inclined so as to broaden an interval therebetween as going toward the opposite direction to the insertion direction f (i.e. the withdrawal direction s). The intermediate inverse-tapering parts 15, which are continuous to leading ends of the back-side tapering parts 14 respectively, are inclined so as to narrow an interval therebetween as going toward the opposite direction to the insertion direction f (i.e. the withdrawal direction s). The tip-side tapering parts 16, which are continuous to leading ends of the intermediate inverse-tapering parts 15 respectively, are inclined so as to broaden an interval therebetween as going toward the opposite direction to the insertion direction f (i.e. the withdrawal direction s). Respective joint points between the intermediate inverse-tapering parts 15 and the tip-side tapering parts 16 constitute a pair of contact parts 17. A distance d between the pair of contact parts 17 is set to be the narrowest dimension inside the terminal connection parts 12 in pairs. The distance d between the pair of contact parts 17 is set to be somewhat larger than a width dimension of the male terminal 40 under an unloaded condition where the terminal connection parts are subjected to no external force, and the contact parts 17 are respectively positioned at non-touching positions separate from the male terminal 40. The pair of terminal connection parts 12 are adapted so that, if they are subjected to an external force in a direction to approach each other, they are capable of elastic deformation to their touching positions touching the male terminal 40 due to their resulting flexural deformation.

The second connector 30 as a mating connector includes a female connector housing 32 having a connector fitting chamber 31 and the male terminal 40 fixed in the female connector housing 32 to project into the connector fitting chamber 31.

Next, the engagement operation between the first connector 1A and the second connector 30 will be described. In the first connector 1A, the female terminal 10 is positioned at the forward standby position illustrated with a solid line of FIG. 2.

Under this condition, it is performed to insert the male connector housing 2 of the first connector 1A into the connector fitting chamber 31 of the second connector 30. Then, as illustrated in FIG. 3A, the male terminal 40 is inserted between the pair of terminal connection parts 12 of the female terminal 10 through the terminal insertion slot 2a of the male connector housing 2. With progress of the insertion of the male terminal 40, as illustrated in FIG. 3B, the tip of the male terminal 40 comes in touch with the pressure-receiving part 13 of the female terminal 10. With further progress of the insertion of the male terminal 40, due to the pressing power of the male terminal 40, the female terminal 10 starts to move in the terminal housing 3, from the forward standby position toward the rearward contact position. With the moving of the female terminal 10 toward the rearward contact position, the tapering surfaces 4 of the terminal housing 3 press the back-side tapering parts 14 of the female terminal 10, so that the terminal connection parts 12 in pairs are elastically displaced to a direction to narrow an interval therebetween (i.e. moving toward the touching position). Then, as illustrated in FIG. 3C, when the male terminal 40 reaches a position just before the insertion completion position or occupies the insertion completion position, the terminal connection parts 12 in pairs are moved and finally positioned at the touching positions, so that the pair of contact parts 17 come in touch with the male terminal 40 initially. Thus, at the insertion completion position, there is realized a condition that the pair of contact parts 17 of the female terminal 10 touch the male terminal 40.

If the first connector 1A and the second connector 30 under their engagement condition are subjected to an external force in a direction to separate them from each other, then the male terminal 40 moves inside the pair of the terminal connection parts 12 in the withdrawal direction s. During this moving process, the female terminal 10 receives, from the male terminal 40 and through the pair of contact parts 17, an external force in the withdrawal direction s due to the frictional resistance. Simultaneously, the back-side tapering parts 14 receive an external force (component force) in the withdrawal direction s from the tapering surfaces 4 of the male connector housing 2. In this way, with the cancellation of the engagement between the connectors, the female terminal 10 moves from the rearward contact position to the forward standby position.

In the process of inserting the male terminal 40 into the terminal connection parts 12, as mentioned above, at least the female terminal 40 does not slide on the contact parts 17 of the female terminal 10 till the male terminal 40 presses the pressure-receiving part 13 of the female terminal 10 so that the terminal connection parts 12 receive the pressing force in the direction of touching, from the male terminal 40. For this reason, the sliding stroke of the male terminal is shortened by just that much, so that it is possible to reduce sliding wear of the male terminal 40 and the female terminal 10. Moreover, also in the process of separating the male terminal 40 from the inside of the terminal connection parts 12, the sliding stroke is shortened due to the operation substantially opposite to that mentioned above, so that the sliding wear of the male terminal 40 and the female terminal 10 can be reduced. From above, there is no need of increasing the thickness of plating in view of improving the durability of male terminal 40 and the female terminal 10, which results in cost reduction.

In the first embodiment, the pressure-receiving part 13 is set at a position where it is pressed by the male terminal 40 in the latter half stroke during the insertion process of the male terminal 40. Then, when the male terminal 40 reaches the position just before the insertion completion position or occupies the insertion completion position, the contact parts 17 of the pair of terminal connection parts 12 are moved and finally positioned at the touching positions, so that the pair of contact parts 17 come in touch with the male terminal 40 initially. Accordingly, the mating strength between the connectors becomes reduced till the pressure-receiving part 13 is pressed by the male terminal 40. Additionally, as the sliding stroke between the male terminal 40 and the contact parts 17 of the female terminal 17 is remarkably short, it is possible to reduce the sliding wear of the male terminal 40 and the male terminal 10 to the utmost.

### Second Embodiment

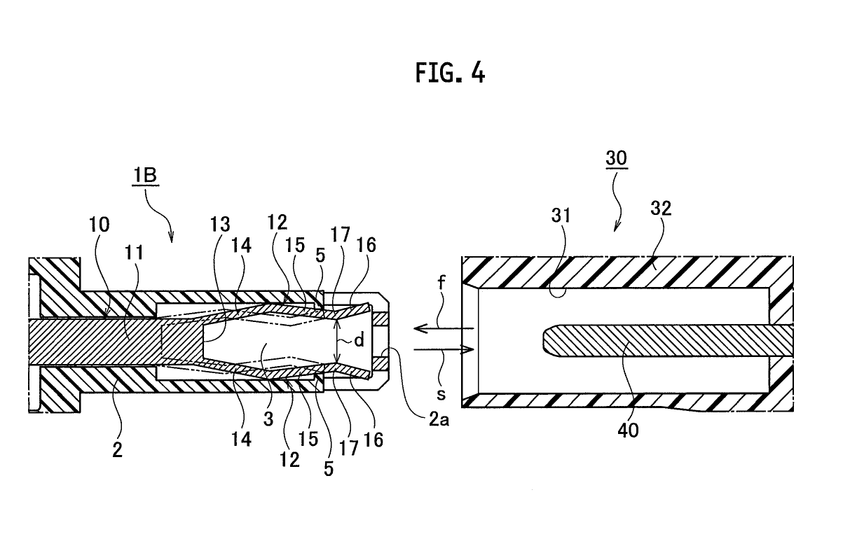

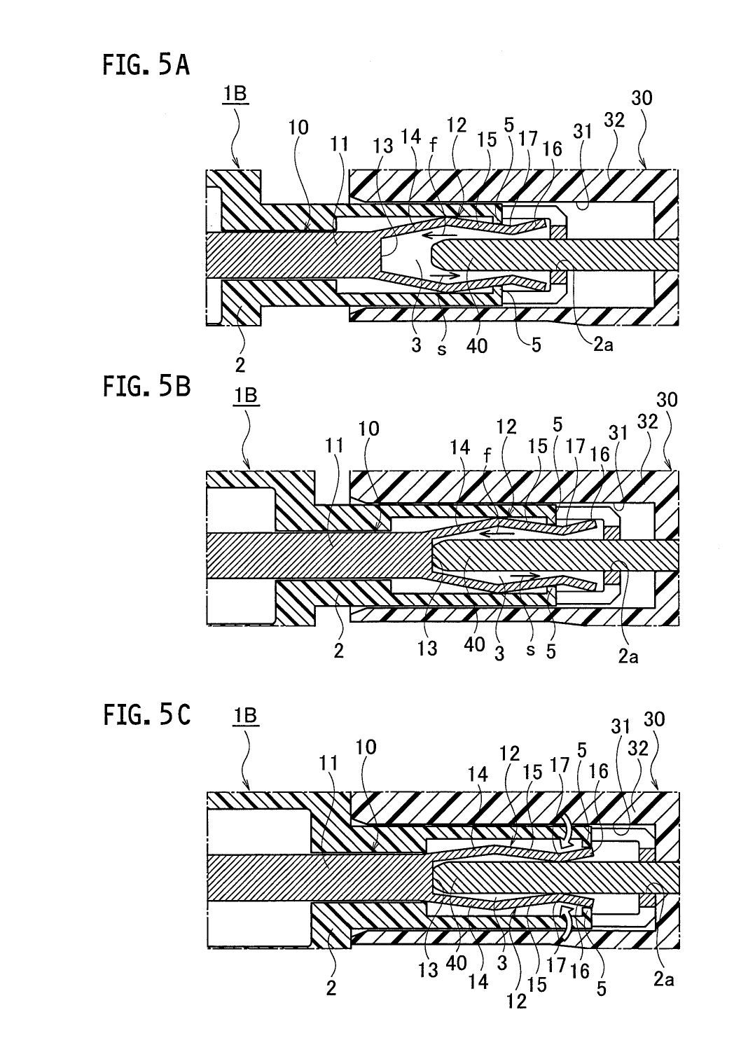

FIGS. 4 and 5 illustrate a second embodiment. A first connector 1B according to the second embodiment differs from the first connector 1A according to the first embodiment in the constitution of the pressing part. In the first connector 1B according to the second embodiment, the pressing part is formed by pressing projection parts 5 projecting into the terminal housing 3 to press the tip-side tapering parts 16. In the first connector 1B according to the second embodiment, additionally, the tapering surfaces 4 are not provided on the inner face of the terminal housing 3 of the male connector housing 2.

As the other constitution of the second embodiment is similar to that of the first embodiment, elements identical to those of the first embodiment will be indicated with the same reference numerals in the figures and their overlapping descriptions are omitted.

Next, the engagement operation between the first connector 1B and the second connector 30 according to the second embodiment will be described. In the first connector 1B, the female terminal 10 is positioned at the forward standby position illustrated with a solid line of FIG. 4.

Under this condition, it is performed to insert the male connector housing 2 of the first connector 1B into the connector fitting chamber 31 of the second connector 30. Then, as illustrated in FIG. 5A, the male terminal 40 is inserted between the pair of terminal connection parts 12 of the female terminal 10 through the terminal insertion slot 2a of a male connector housing 21. With progress of the insertion of the male terminal 40, as illustrated in FIG. 5B, the tip of the male terminal 40 comes in touch with the pressure-receiving part 13 of the female terminal 10. With further progress of the insertion of the male terminal 40, due to the pressing power of the male terminal 40, the female terminal 10 starts to move in the terminal housing 3, from the forward standby position toward the rearward contact position. With the moving of the female terminal 10 toward the rearward contact position, the pair of pressing projection parts 5 of the terminal housing 3 press the tip-side tapering parts 16 of the female terminal 10, so that the terminal connection parts 12 in pairs are elastically displaced to a direction to narrow an interval therebetween (i.e. moving toward the touching position). Then, as illustrated in FIG. 5C, when the male terminal 40 reaches a position just before the insertion completion position or occupies the insertion completion position, the terminal connection parts 12 in pairs are moved and finally positioned at the touching positions, so that the pair of contact parts 17 come in touch with the male terminal 40 initially. Thus, at the insertion completion position, there is realized a condition that the pair of contact parts 17 of the female terminal 10 touch the male terminal 40.

If the first connector 1B and the second connector 30 under their engagement condition are subjected to an external force in a direction to separate them from each other, then the male terminal 40 moves inside the pair of the terminal connection parts 12 in the withdrawal direction s. During this moving process, the female terminal 10 receives, from the male terminal 40 and through the pair of contact parts 17, an external force in the withdrawal direction s due to the frictional resistance. Simultaneously, the tip-side tapering parts 16 receive an external force (component force) in the withdrawal direction s from the pressing projection parts 5 of the male connector housing 2. In this way, with the cancellation of the engagement between the connectors, the female terminal 10 moves from the rearward contact position to the forward standby position.

Also in the second embodiment, as similar to the first embodiment, in the process of inserting the male terminal 40 into the terminal connection parts 12, at least the female terminal 40 does not slide on the contact parts 17 of the female terminal 10 till the male terminal 40 presses the pressure-receiving part 13 of the female terminal 10 so that the terminal connection parts 12 receive the pressing force in the direction of touching, from the male terminal 40. For this reason, the sliding stroke of the male terminal 40 is shortened by just that much, so that it is possible to reduce sliding wear of the male terminal 40 and the female terminal 10. Moreover, also in the process of separating the male terminal 40 from the inside of the terminal connection parts 12, the sliding stroke is shortened due to the operation substantially opposite to that mentioned above, the sliding wear of the male terminal 40 and the female terminal 10 can be reduced. From above, there is no need of increasing the thickness of plating in view of improving the durability of male terminal 40 and the female terminal 10, which results in cost reduction.

### Modifications

Although the connector is constructed, in common with the first and the second embodiments, so that when cancelling the engagement between the connectors, the female terminal 10 is moved from the rearward contact position to the forward standby position by an external force transmitted through the male terminal 40, there may be provided an urging member (e.g. spring) for urging the female terminal 10 to the forward standby position. This way the female terminal 10 can be reliably returned to the forward standby position at cancelling the engagement of the connectors.

What is claimed is:

1. A connector, comprising:
a connector housing having a terminal housing; and
a female terminal housed in the terminal housing, the female terminal comprising a base part and a pair of terminal connection parts into which a male terminal can be inserted, a base end side of each of the terminal connection parts supported by the base part, wherein
the female terminal is housed so as to be capable of moving in the terminal housing in an insertion direction of the male terminal, the female terminal comprising a pressure-receiving part to be pressed by the male terminal during an insertion process of the male terminal,
the pair of terminal connection parts each comprises:
a back-side tapering part inclined so as to broaden an interval therebetween as going toward from the base part to the opposite direction to the insertion direction of the male terminal;
an intermediate inverse-tapering part continuous to a leading end of the back-side tapering part and inclined so as to narrow an interval therebetween as going toward the opposite direction to the insertion direction of the male terminal; and
a tip-side tapering part continuous to a leading end of the intermediate inverse-tapering part and inclined so as to broaden an interval therebetween as going toward the opposite direction to the insertion direction of the male terminal,
the terminal connection part is positioned at a non-touching position separated from the inserted male terminal and provided so as to be capable of changing a position to a touching position where the terminal connection part comes in touch with the male terminal, and
the connector housing is provided with a pressing part to be pressing the terminal connection part toward the touching position during a movement process of the female terminal due to a pressure of the male terminal.

2. The connector of claim 1, wherein
the pressing part is a tapering surface which is formed on an inner face of the terminal housing to press the back-side tapering parts.

3. The connector of claim 1, wherein
the pressing part is a pressing projection part which is formed on a tip end of the connector housing and projects into the terminal housing to press the tip-side tapering parts.
